(19) United States
(12) Patent Application Publication
(10) Pub. No.: US 2022/0385326 A1
(43) Pub. Date: Dec. 1, 2022

(54) ELECTROMAGNETIC FIELD SAFE EARBUDS

(71) Applicants: Fredericus A. Colen, Ponte Vedra Beach, FL (US); Alexandra Romanova, Ponte Vedra Beach, FL (US)

(72) Inventors: Fredericus A. Colen, Ponte Vedra Beach, FL (US); Alexandra Romanova, Ponte Vedra Beach, FL (US)

(21) Appl. No.: 17/662,929

(22) Filed: May 11, 2022

Related U.S. Application Data
(60) Provisional application No. 63/202,073, filed on May 26, 2021.

(51) Int. Cl. H04B 1/3827; H04R 1/10; H04W 4/80

(52) U.S. Cl. CPC H04B 1/385; H04R 1/1016; H04R 1/1091; H04W 4/80; H04R 2420/07; H04B 2001/3872

(57) ABSTRACT

An apparatus and method for protecting a user's brain and heart from radiation is herein disclosed. In particular, a wireless headphone provides the radiation-emitting components in an electronics module spaced from both of those body parts. The radiation-emitting components include, but are not limited to, a wireless antenna or a wireless receiver. Thus, the present invention enables all the utility that wireless headphones offer without the negative health effects associated therewith.

### CROSS-REFERENCE TO RELATED APPLICATION

This application claims the benefit of priority of U.S. provisional application No. 63/202,073, filed May 26, 2021, the contents of which are herein incorporated by reference.

### BACKGROUND OF THE INVENTION

The present invention relates to earbuds (and other wireless headphones) and, more particularly, to wireless electromagnetic field (EMF) safe earbuds.

Earbuds are a consumer device that millions of individuals use daily. They are convenient to use, offer high-quality sound, and generally allow users more freedom when talking on the phone than the alternative (e.g., holding the phone to the head).

However, headphones, which include earbuds, have potential safety hazards. For example, conventional earbuds can potentially cause damage to the brain due to radiation emitted from wireless devices, such as ones that include short-range wireless receivers and/or emitters (e.g., BLUETOOTH™ receivers and/or emitters). Many of these earbuds (or other headphone types) are placed directly within or proximal to the ear canal, often directly contacting the user's skin.

While their EMF radiation is typically much less than what is emitted from an average cell phone, the placement of radiation-emitting components is of concern. With how conventional earbuds are configured, these short-range electronics and antennas are typically positioned proximal to the user's brain. Due to the nature of the product and its design, these earbuds are often used for long periods, increasing the risk of adverse long-term health effects. Foregoing the use of wireless earbuds takes away all the benefits of the earbuds and even further exposes a user to radiation (e.g., when the phone is held directly to the ear).

As can be seen, there is a need for earbuds (or other equivalent wireless headphones) that incorporate the teachings of the present invention.

### SUMMARY OF THE INVENTION

In one aspect of the present invention, a wireless headphone is disclosed that comprises: a first earbud configured to be positioned in or on a first user ear, in use, the first earbud comprising a first speaker; a first wire extension comprising a first end and a second end, with the first end of the first wire extension being coupled to the first earbud; and a first electronics module: housing a first wireless antenna or a first wireless receiver, coupled to the second end of the first wire extension and electrically coupled to the first speaker by the first wire extension, and configured to hang below the first earbud, in use.

In certain embodiments, the first wireless antenna or the wireless receiver is configured to emit radiation.

In certain embodiments, the wireless headphone further comprises a battery positioned in the first earbud or the first electronics module, with the battery being electrically coupled to the speaker and the wireless antenna or the wireless receiver.

In certain embodiments, the first wire extension is dimensioned to space the first electronics module from a user brain and a user heart, in use.

In certain embodiments, the wireless headphone further comprises: a second earbud configured to be positioned in or on a second user ear, in use, the second earbud comprising a second speaker; a second wire extension comprising a first end and a second end, with the first end of the second wire extension being coupled to the second earbud; and a second electronics module: housing a second wireless antenna or a second wireless receiver, coupled to the second end of the second wire extension and electrically coupled to the second speaker by the second wire extension, and configured to hang below the second earbud, in use.

In certain embodiments, the first wire extension is dimensioned to space the first electronics module from a user brain and a user heart, in use, and the second wire extension is dimensioned to space the second electronics module from the user brain and the user heart, in use.

In certain embodiments, the wireless headphone further comprises: a second earbud configured to be positioned in or on a second user ear, in use, the second earbud comprising a second speaker; and a second wire extension comprising a first end and a second end, with the first end of the second wire extension being coupled to the second earbud and the second end of the second wire extension being coupled to the first electronics module.

In certain embodiments, the first wire extension and the second wire extension are substantially equal in length.

In certain embodiments, the first wire extension comprises a first length, and the second wire extension comprises a second length that is different from the first length.

In another aspect of the present invention, a method of protecting a user from radiation is disclosed, with the method comprising the steps of: providing a wireless headphone comprising: a first earbud comprising a first speaker; a first wire extension comprising a first end and a second end, with the first end of the first wire extension being coupled to the first earbud; and a first electronics module: housing a first wireless antenna or a first wireless receiver, and coupled to the second end of the first wire extension and electrically coupled to the first speaker by the first wire extension; and positioning the first earbud in or on a first user ear such that the first electronics module hangs below the first earbud.

In certain embodiments, the first electronics module is positioned proximal a user shoulder.

In certain embodiments, the first electronics module is positioned under a user chin.

In certain embodiments, the first electronic module is positioned between a user brain and a user heart.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a front perspective view of a first embodiment of the present invention;

FIG. 2 is a front elevation view of the first embodiment of the present invention, in use;

FIG. 3 is a front perspective view of a second embodiment of the present invention; and

FIG. 4 is a front elevation view of the second embodiment of the present invention, in use.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, an embodiment of the present invention provides a wireless earbud or headphone. As used herein, the term “headphone” encompasses various configurations, including earbuds. As used herein, the term earbud refers to the component of a headphone positioned in, on, or around a user's ear. Further, the term “wireless” refers to headphones that do not use a wire to connect to another device (e.g., a personal computer or smartphone) for audio input.

In certain embodiments, the headphone may include: a speaker configured to be disposed proximal to a user's ear, in use; a multiple wire extension that couples the speaker to the electronics module; and the electronics module, with a wireless antenna or receiver; the electronics module with wireless antenna or receiver being configured to be disposed further away and distal a user ear, in use. Additionally, a battery for the earbud and its electronics module can be positioned near or within the electronics module, or it could also be positioned in the part of the earbud near the ear and then connected with wires to the electronics module, provided no high-frequency signals (as opposed to low-frequency audio signals) are being transmitted to the parts of the earbud near the ear, to keep it EMF safe.

Embodiments of the present invention remove the EMF radiating part (such as a BLUETOOTH™ electronics and antenna/receiver) from the proximity to the brain. As described above, existing headphones radiate EMFs to the brain due to the proximity of the source of the EMF. Embodiments of the present invention drastically increase the distance from the EMF radiating part to the brain using wire extensions, increasing the safety of use thereof.

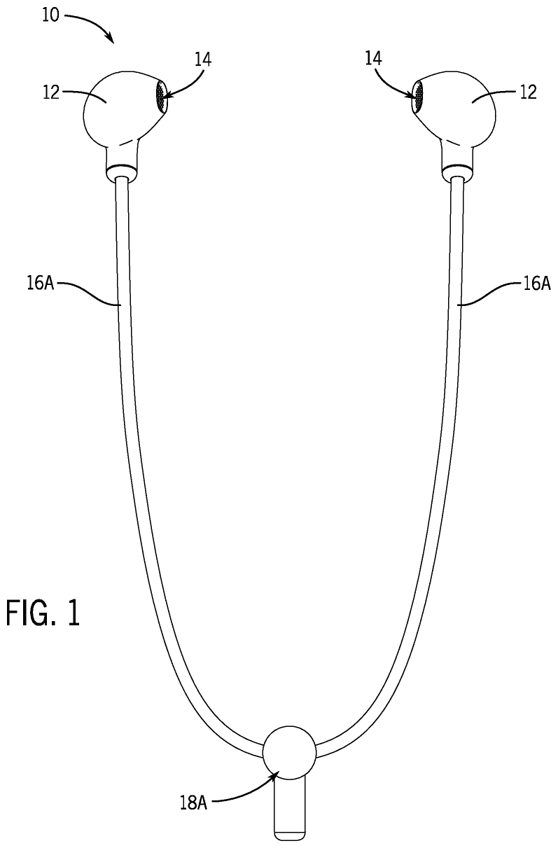

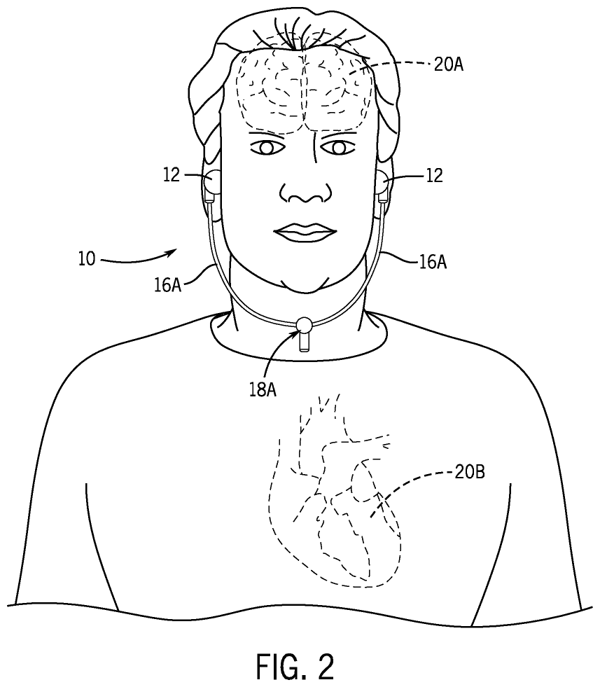

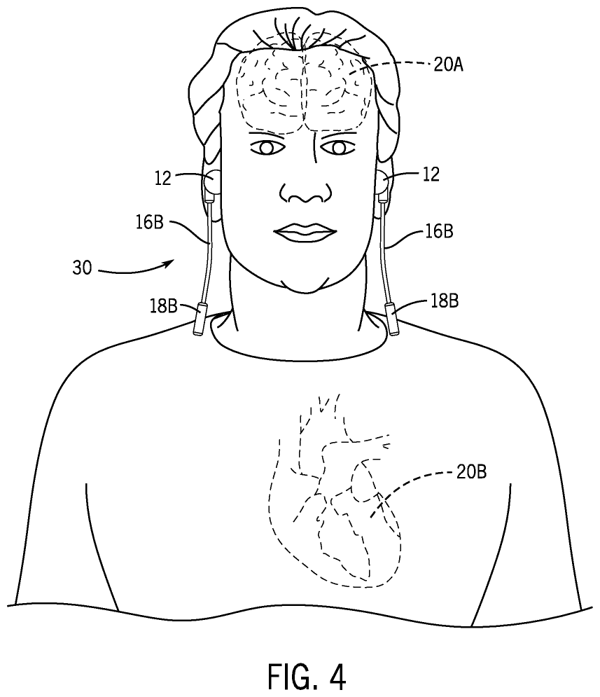

Referring now to FIGS. 1-2, a wireless headphone 10 (e.g., a pair of earbuds that are connected) include first and second earbuds 12 with respective speakers 14, a wire extension 16A (which may comprise a plurality of wires), and an electronics module 18A (that includes a wireless antenna/receiver housed therewithin and hidden from view in the figures) coupled at the end of the wire extension 16A. As discussed above, the wireless antenna/receiver is the component of the headphone 10 that emits radiation. The wire extension 16A advantageously spaces the radiation-emitting components (the modules 18A) a pre-determined distance away from the earbuds 12, which are placed in or around a user's ear in use. By configuring each of the earbud(s) 12 in this manner, the radiating part 18A is moved as far as possible away from the brain 20A and can also be configured to be kept far away from the heart 20B of the user, as demonstrated in FIGS. 2 and 4. In certain embodiments, the wire extension 16A may comprise several individual wires inside the extension 16A to facilitate the speaker connection and potentially the battery (hidden from view in the figures), depending on its placement.

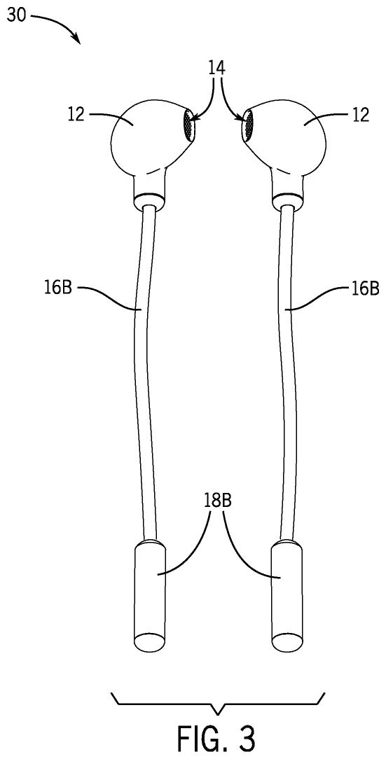

As evidenced by the two embodiments shown in FIGS. 1-2 and 3-4, respectively, the headphone 10 (first embodiment), 30 (second embodiment) could be configured in various forms. For example, as shown in FIGS. 1-2, the wire extensions 16A come together to form a singular headphone 10, which can include a single electronic module 18 with a wireless antenna/receiver or, for example, two electronic modules 18 with a wireless antenna/receiver. In other embodiments, as shown in FIGS. 3-4, the headphone 30 may include wire extensions 16B that are uncoupled, with respective electronics modules 18B being coupled to the lower ends of the wire extensions 16B. In this configuration, the electronics modules 18B with the wireless antenna/receiver associated with each earbud 12 hangs down towards, touching or hanging on or behind the shoulder(s), as shown in FIG. 4. Operation of the second embodiment is otherwise the same as the first described embodiment.

As those with skill in the art will appreciate, the placement of the electronic module(s) 18A, 18B with antenna/receiver could be adjusted (by changing the length of the wire extensions 16A, 16B) such that it is located either, for example: (1) underneath the chin and as far down as desired, (2) behind and below the head, as far as possible from the brain/heart, (3) underneath the chin, asymmetrically towards the right side (distal the heart), and as far down as desired, or (4) behind and below the head, asymmetrically towards the right side (away from the heart) and as far down as desired. As will be appreciated, the wire extensions 16A, 16B (of each respective embodiment) could be approximately equal in length or differ in length, leading to the asymmetrical positioning referenced above.

By way of example, the first embodiment 10 could have wire extensions 16A equal in length of approximately 7 inches each. Alternatively, the left wire extension 16A (relative to the orientation shown in FIG. 1) could be approximately 5.5 inches long and the right wire extension 16A could be approximately 8 inches long, resulting in an asymmetrical positioning that puts the electronics module 18A further from the heart 20B. Similarly, the second embodiment 30 could have wire extensions 16A with a length of approximately 3-4 inches. However, it will be appreciated by those with skill in the art that these dimensions are exemplary in nature, and other dimensional ranges may be appropriated, provided that they result in the electronics module(s) 18A, 18B being spaced from the wearer's brain 20A and heart 20B.

In all these embodiments, the source of EMF radiation is removed from the proximity to the brain and potentially also to the heart. While the invention has been described in the context of radiation emitted from BLUETOOTH™ devices, it will be appreciated by those with skill in the art that the present invention may be suitable for use in conjunction with other forms of short-range wireless technology that emit radiation. The present invention's teachings could also be applied to other body-worn devices that emit radiation.

Further, these earbuds may be used just like any other conventional earbud (or headphone), with the radiation-emitting electronic module, including the antenna/receiver being safely moved away from the most vulnerable human body parts. Methods of making the present invention would be readily apparent to those with skill in the art from the foregoing disclosure. Specifically, they may be manufactured using similar processes as conventional techniques, with appropriate modifications made to achieve the end results discussed herein (e.g., positioning of radiation-emitting components away from body parts more susceptible to this radiation).

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A wireless headphone comprising:
a first earbud configured to be positioned in or on a first user ear, in use, the first earbud comprising a first speaker;
a first wire extension comprising a first end and a second end, with the first end of the first wire extension being coupled to the first earbud; and
a first electronics module:
housing a first wireless antenna or a first wireless receiver,
coupled to the second end of the first wire extension and electrically coupled to the first speaker by the first wire extension, and
configured to hang below the first earbud, in use.

2. The wireless headphone of claim 1, wherein the first wireless antenna or the wireless receiver is configured to emit radiation.

3. The wireless headphone of claim 1, further comprising a battery positioned in the first earbud or the first electronics module, the battery being electrically coupled to the speaker and the wireless antenna or the wireless receiver.

4. The wireless headphone of claim 1, wherein the first wire extension is dimensioned to space the first electronics module from a user brain and a user heart, in use.

5. The wireless headphone of claim 4, wherein the first wire extension is approximately 3 to 4 inches long.

6. The wireless headphone of claim 1, further comprising:
a second earbud configured to be positioned in or on a second user ear, in use, the second earbud comprising a second speaker;
a second wire extension comprising a first end and a second end, with the first end of the second wire extension being coupled to the second earbud; and
a second electronics module:
housing a second wireless antenna or a second wireless receiver,
coupled to the second end of the second wire extension and electrically coupled to the second speaker by the second wire extension, and
configured to hang below the second earbud, in use.

7. The wireless headphone of claim 6, wherein the first wire extension is dimensioned to space the first electronics module from a user brain and a user heart, in use, and the second wire extension is dimensioned to space the second electronics module from the user brain and the user heart, in use.

8. The wireless headphone of claim 7, wherein the first wire extension is approximately 3 to 4 inches.

9. The wireless headphone of claim 1, further comprising:
a second earbud configured to be positioned in or on a second user ear, in use, the second earbud comprising a second speaker; and
a second wire extension comprising a first end and a second end, with the first end of the second wire extension being coupled to the second earbud and the second end of the second wire extension being coupled to the first electronics module.

10. The wireless headphone of claim 9, wherein the first wire extension and the second wire extension are substantially equal in length.

11. The wireless headphone of claim 10, wherein the first wire extension and the second wire extension both comprise a length of approximately 7 inches.

12. The wireless headphone of claim 9, wherein the first wire extension comprises a first length, and the second wire extension comprises a second length that is different from the first length.

13. The wireless headphone of claim 12, wherein the first length is approximately 5.5 inches and the second length is approximately 8 inches.

14. A method of protecting a user from radiation, the method comprising the steps of:
providing a wireless headphone comprising:
a first earbud comprising a first speaker;
a first wire extension comprising a first end and a second end, with the first end of the first wire extension being coupled to the first earbud; and
a first electronics module: housing a first wireless antenna or a first wireless receiver, and coupled to the second end of the first wire extension and electrically coupled to the first speaker by the first wire extension; and
positioning the first earbud in or on a first user ear such that the first electronics module hangs below the first earbud.

15. The method of claim 14, wherein the first electronics module is positioned proximal a user shoulder.

16. The method of claim 14, wherein the first electronics module is positioned under a user chin.

17. The method of claim 14, wherein the first electronic module is positioned between a user brain and a user heart.
